(19) United States
(12) Patent Application Publication
(10) Pub. No.: US 2017/0182715 A1
(43) Pub. Date: Jun. 29, 2017

(54) STEREOSCOPIC MODELING APPARATUS, INFORMATION PROCESSING DEVICE, AND PRODUCTION METHOD OF OUTPUT OBJECT

(71) Applicant: KAZUO HAIDA, Kanagawa (JP)

(72) Inventor: KAZUO HAIDA, Kanagawa (JP)

(73) Assignee: Ricoh Company, Ltd., Tokyo (JP)

(21) Appl. No.: 15/388,480

(22) Filed: Dec. 22, 2016

(30) Foreign Application Priority Data
Dec. 28, 2015 (JP) 2015-257294

(51) Int. Cl. B29C 67/00; B33Y 30/00; B33Y 50/02; B33Y 10/00

(52) U.S. Cl. CPC B29C 67/0088; B29C 67/0059; B29C 67/0085; B33Y 10/00; B33Y 30/00; B33Y 50/02; B29C 2035/0827

(57) ABSTRACT

A three-dimensional fabrication apparatus includes a modeling unit that model a shape of a stereoscopic image by discharging and laminating droplets corresponding to a pixel based on height information indicating a height of each pixel of the stereoscopic image, wherein the modeling unit models at least an outermost surface of the shape by laminating droplets discharged with a discharge amount that is less than the discharge amount of the droplets used to model at least part of a shape other than the outermost surface in the shape, and forms the color by laminating droplets discharged with a discharge amount that is less than the discharge amount of the droplets used to model at least the part of the shape other than the outermost surface in the shape and is not less than the discharge amount of the droplets used to model the outermost surface.

### CROSS-REFERENCE TO RELATED APPLICATIONS

The present application claims priority under 35 U.S.C. §119 to Japanese Patent Application No. 2015-257294 filed Dec. 28, 2015. The contents of which are incorporated herein by reference in their entirety.

### BACKGROUND OF THE INVENTION

1. Field of the Invention

The present invention relates to a three-dimensional fabrication apparatus, an information processing device, and a production method of an output object.

2. Description of the Related Art

Conventionally, as a method of modeling a three-dimensional solid object, an inkjet method, a melt deposition method, a rapid prototyping method, an inkjet binder method, an optical modeling method, and a powder sintering method and the like are known.

Japanese Patent No. 4596743 discloses an inkjet method, in which a first recording head is used to form a first undulation layer representing a shape of compositions that constitute an image, a second recording head is used to record the image on the first undulation layer, a third recording head is used to form a second undulation layer representing texture of a pattern of the image on the image, and a diameter of droplets forming the second undulation layer is made smaller than a diameter of droplets forming the first undulation layer.

According to the technology disclosed in Japanese Patent No. 4596743, because the diameter of the droplets forming the second undulation layer is made smaller than the diameter of the droplets forming the first undulation layer, fine irregularities can be expressed on the second undulation layer, which makes it possible to appropriately express the texture of the image pattern.

However, in the technology disclosed in Japanese Patent No. 4596743, the diameter of the droplets forming the first undulation layer is larger than the diameter of the droplets forming the second undulation layer. Therefore, the accuracy of a lamination layer of the first undulation layer is not so high, and it is therefore estimated that the surface of the first undulation layer is not smooth and has some irregularities.

Therefore, in the technology disclosed in Japanese Patent No. 4596743, the image recorded on the first undulation layer is affected by the irregularities on the surface of the first undulation layer, and it is therefore estimated that color reproducibility is reduced.

In view of the above conventional problems, there is a need to provide a three-dimensional fabrication apparatus, an information processing device, and a production method of an output object capable of improving the color reproducibility of a modeled solid object.

### SUMMARY OF THE INVENTION

According to exemplary embodiments of the present invention, there is provided a three-dimensional fabrication apparatus comprising: a modeling unit configured to model a shape of a stereoscopic image by discharging and laminating droplets corresponding to a pixel based on height information indicating a height of each pixel of the stereoscopic image and to model the stereoscopic image by discharging and laminating droplets corresponding to the pixel on the modeled shape to form a color on the shape based on color information indicating a color of each pixel of the stereoscopic image, wherein the modeling unit is configured to model at least an outermost surface of the shape by laminating droplets discharged with a discharge amount that is less than the discharge amount of the droplets used to model at least part of a shape other than the outermost surface in the shape, and form the color by laminating droplets discharged with a discharge amount that is less than the discharge amount of the droplets used to model at least the part of the shape other than the outermost surface in the shape and is not less than the discharge amount of the droplets used to model the outermost surface.

Exemplary embodiments of the present invention also provide an information processing device comprising: a layer information generating unit configured to generate layer information indicating an arrangement of pixels on each layer for modeling a stereoscopic image based on height information indicating a height of each pixel of the stereoscopic image and color information indicating a color of each pixel of the stereoscopic image, wherein, when the layer is a layer for modeling an outermost surface of a shape of the stereoscopic image, the layer information indicates lamination of the layer by discharging droplets corresponding to a pixel with a discharge amount that is less than a discharge amount of droplets used to model at least part of a shape other than the outermost surface in the shape, and when the layer is a layer for forming colors of the stereoscopic image, the layer information indicates lamination of the layer by discharging droplets corresponding to a pixel with a discharge amount that is less than the discharge amount of droplets used to model at least the part of the shape other than the outermost surface in the shape and is not less than the discharge amount of droplets used to model the outermost surface.

Exemplary embodiments of the present invention also provide a production method of an output object configured to produce the output object by laminating droplets to model a stereoscopic image on a recording medium, the production method comprising: modeling a shape of the stereoscopic image on the recording medium by discharging and laminating droplets corresponding to a pixel on the recording medium based on height information indicating a height of each pixel of the stereoscopic image, and modeling the stereoscopic image on the recording medium by discharging and laminating droplets corresponding to a pixel on the modeled shape and forming colors on the shape based on color information indicating a color of each pixel of the stereoscopic image, wherein the modeling configured to include modeling at least part of a shape other than an outermost surface in the shape by discharging and laminating droplets, modeling the outermost surface by laminating droplets discharged with a discharge amount that is less than the discharge amount of the droplets used to model at least the part of the shape other than the outermost surface in the shape, and forming the color by laminating droplets discharged with a discharge amount that is less than the discharge amount of the droplets used to model at least the part of the shape other than the outermost surface in the shape and is not less than the discharge amount of the droplets used to model the outermost surface.

### BRIEF DESCRIPTION OF THE DRAWINGS

FIG. 1 is a block diagram illustrating an example of a schematic configuration of an inkjet recording device according to a present embodiment;

FIG. 2 is a block diagram illustrating an example of a hardware configuration of a controller according to the present embodiment;

FIG. 3 is a schematic diagram illustrating an example of a mechanical configuration of a head unit according to the present embodiment;

FIG. 4 is a block diagram illustrating an example of a functional configuration of the inkjet recording device according to the present embodiment;

FIG. 5 is a diagram illustrating an example of color information according to the present embodiment;

FIG. 6 is a diagram illustrating an example of height information according to the present embodiment;

FIG. 7 is an explanatory diagram illustrating an example of a method of generating layer information according to the present embodiment;

FIG. 8 is an explanatory diagram of an example of a method of modeling a stereoscopic image according to the present embodiment;

FIG. 9 is an explanatory diagram of an example of the method of modeling the stereoscopic image according to the present embodiment;

FIG. 10 is an explanatory diagram of an example of the method of modeling the stereoscopic image according to the present embodiment;

FIG. 11 is an explanatory diagram of an example of the method of modeling the stereoscopic image according to the present embodiment;

FIG. 12 is an explanatory diagram of an example of the method of modeling the stereoscopic image according to the present embodiment;

FIG. 13 is an explanatory diagram of an example of the method of modeling the stereoscopic image according to the present embodiment;

FIG. 14 is an explanatory diagram of an example of the method of modeling the stereoscopic image according to the present embodiment;

FIG. 15 is an explanatory diagram of an example of the method of modeling the stereoscopic image according to the present embodiment;

FIG. 16 is an explanatory diagram of an example of the method of modeling the stereoscopic image according to the present embodiment;

FIG. 17 is an explanatory diagram of an example of the method of modeling the stereoscopic image according to the present embodiment;

FIG. 18 is an explanatory diagram of an example of the method of modeling the stereoscopic image according to the present embodiment;

FIG. 19 is a flowchart illustrating an example of a flow of production processing procedure of an output object according to the present embodiment;

FIG. 20 is a flowchart illustrating an example of modeling processing at Step S111 in the flowchart of FIG. 19; and

FIG. 21 is a schematic diagram illustrating an example of a mechanical configuration of a head unit according to a first modification.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

Exemplary embodiments of a three-dimensional fabrication apparatus, an information processing device, and a production method of an output object according to the present invention will be explained in detail below with reference to the accompanying drawings. As the three-dimensional fabrication apparatus, an inkjet recording device that models (forms) a stereoscopic image on a recording medium by discharging an ultraviolet curable ink (active energy ray curable ink) as a molding agent from an inkjet head of a piezo method to the recording medium will be explained below as an example, however, the embodiments are not limited thereto.

The recording medium may be any medium if the medium can model a stereoscopic image. Examples of the recording medium include, but are not limited to, a recording paper and a canvas. Moreover, the molding agent is not limited to the ultraviolet curable ink, and may therefore be any agent if molding agents do not mix with each other and can obtain shape stability after the completion of a lamination layer. The molding agent may also be a liquid or gel state at the time of laminating. The molding agent may be any ink that softens or cures spontaneously or thermally.

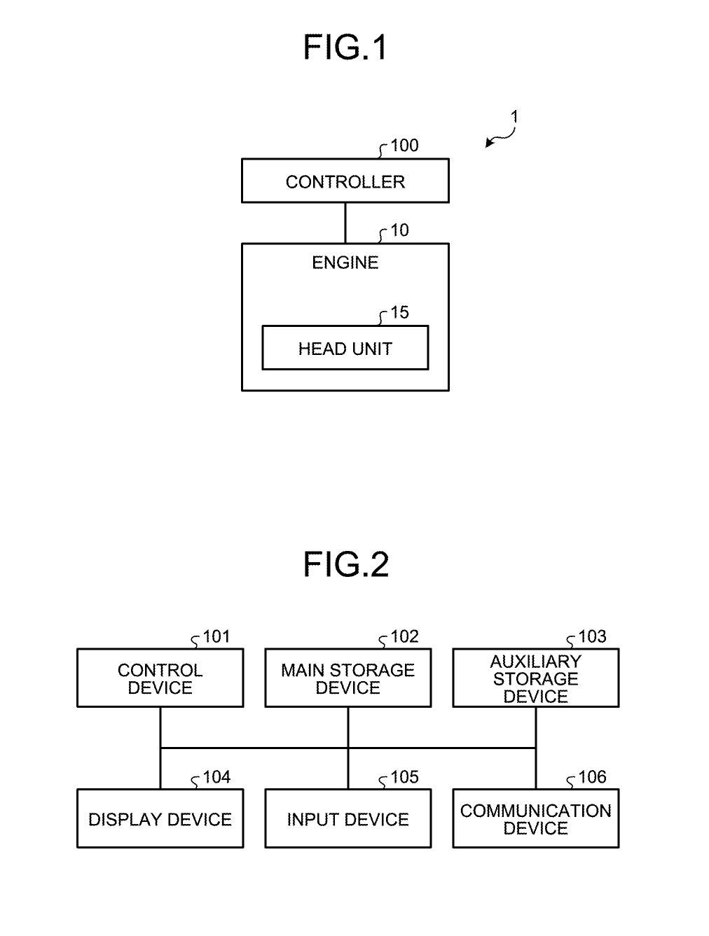

FIG. 1 is a block diagram illustrating an example of a schematic configuration of a three-dimensional fabrication apparatus 1 according to the present embodiment. As illustrated in FIG. 1, the three-dimensional fabrication apparatus 1 includes an engine 10 and a controller 100 (an example of the information processing device).

The engine 10 models (forms) a stereoscopic image on a recording medium. Specifically, a stereoscopic image is modeled on a recording medium by discharging an ultraviolet curable ink from a head unit 15 provided in the engine 10 to be laminated on the recording medium.

The controller 100 performs control to model (form) the stereoscopic image on the recording medium. Specifically, the controller 100 generates information for modeling the stereoscopic image and causes the engine 10 to model the stereoscopic image based on the generated information.

FIG. 2 is a block diagram illustrating an example of a hardware configuration of the controller 100 according to the present embodiment. As illustrated in FIG. 2, the controller 100 includes a control device 101 such as a central processing unit (CPU), a main storage device 102 such as a read-only memory (ROM) and a random access memory (RAM), an auxiliary storage device 103 such as a hard disk drive (HDD) and a solid-state drive (SSD), a display device 104 such as a display, an input device 105 such as a touch panel and a key switch, and a communication device 106 such as a communication interface, which is configured as hardware using a normal computer.

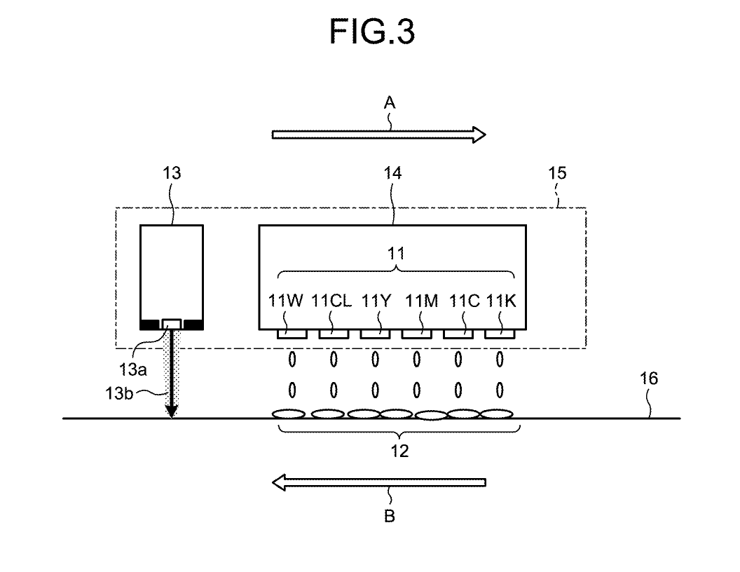

FIG. 3 is a schematic diagram illustrating an example of a mechanical configuration of the head unit 15 according to the present embodiment. As illustrated in FIG. 3, the head unit 15 includes an inkjet head 14 and an ultraviolet irradiation device 13.

The inkjet head 14 has a nozzle array 11 that discharges ultraviolet curable inks to a recording medium 16. FIG. 3 represents a case in which the nozzle array 11 includes a nozzle 11W that discharges an ultraviolet curable ink of white (W), a nozzle 11CL that discharges an ultraviolet curable ink of clear (CL), a nozzle 11Y that discharges an ultraviolet curable ink of yellow (Y), a nozzle 11M that discharges an ultraviolet curable ink of magenta (M), a nozzle 11C that discharges an ultraviolet curable ink of cyan (C), and a nozzle 11K that discharges an ultraviolet curable ink of black (K), however, the configuration of the nozzle array 11 is not limited thereto. For example, the nozzle array 11 does not have to include the nozzle 11CL. Moreover, any number of nozzles 11W, nozzles 11CL, nozzles 11Y, nozzles 11C, nozzles 11M, and nozzles 11K may be provided if each number is one or more.

Among the ultraviolet curable inks, although details will be explained later, the white (W) and the clear (CL) are used for modeling the shape of the stereoscopic image, and the yellow (Y), the cyan (C), the magenta (M), and the black (k) are used for color formation of the stereoscopic image.

The ultraviolet irradiation device 13 has an irradiation unit 13a that irradiates an ultraviolet curable ink 12 laminated on the recording medium 16 by the inkjet head 14 with a curing light 13b which is an ultraviolet ray. The ultraviolet curable ink 12 laminated on the recording medium 16 is cured by the curing light 13b irradiated from the ultraviolet irradiation device 13.

In the present embodiment, the recording medium 16 is conveyed in a direction of arrow B (sub scanning direction). When the recording medium 16 is conveyed to a predetermined position, the conveyance of the recording medium 16 is stopped, and the discharge of the ultraviolet curable ink to the recording medium 16 is started by the inkjet head 14.

Specifically, the head unit 15 reciprocates in a main scanning direction perpendicular to the sub scanning direction while moving in a direction of arrow A (sub scanning direction), causes the inkjet head 14 to discharge the ultraviolet curable ink to the recording medium 16 (in detail, to a drawing area of the recording medium 16), and causes the ultraviolet irradiation device 13 to irradiate the recording medium 16 with the curing light 13b. When reciprocating in the main scanning direction, the head unit 15 may perform unidirectional printing such that the ultraviolet curable ink is discharged from the inkjet head 14 only when it is moving unidirectionally or may perform bidirectional printing such that the ultraviolet curable ink is discharged from the inkjet head 14 when it is moving in both directions.

After one layer of ultraviolet curable ink is laminated on the recording medium 16, the head unit 15 moves to its original position and repeats the operation until n (n≧2) layers of ultraviolet curable ink are laminated.

When the n layers of ultraviolet curable ink are laminated on the recording medium 16 and the stereoscopic image is modeled, the conveyance of the recording medium 16 in the direction of arrow B is restarted, and the recording medium 16 with the stereoscopic image modeled thereon is output from the three-dimensional fabrication apparatus 1.

However, the discharging operation of the head unit 15 is not limited to the method. For example, it may be configured that the head unit 15 in a fixed state is caused to reciprocate in the main scanning direction perpendicular to the sub scanning direction while the recording medium 16 (in detail, a table unit or so to which the recording medium 16 is fixed) is conveyed in the direction of arrow B, and causes the inkjet head 14 to discharge the ultraviolet curable ink to the recording medium 16 and causes the ultraviolet irradiation device 13 to emit the curing light 13b. In this case, when the one layer of ultraviolet curable ink is laminated on the recording medium 16, the recording medium 16 is conveyed to the original position, and the above operation is repeated until the n (n≧2) layers of ultraviolet curable ink are laminated.

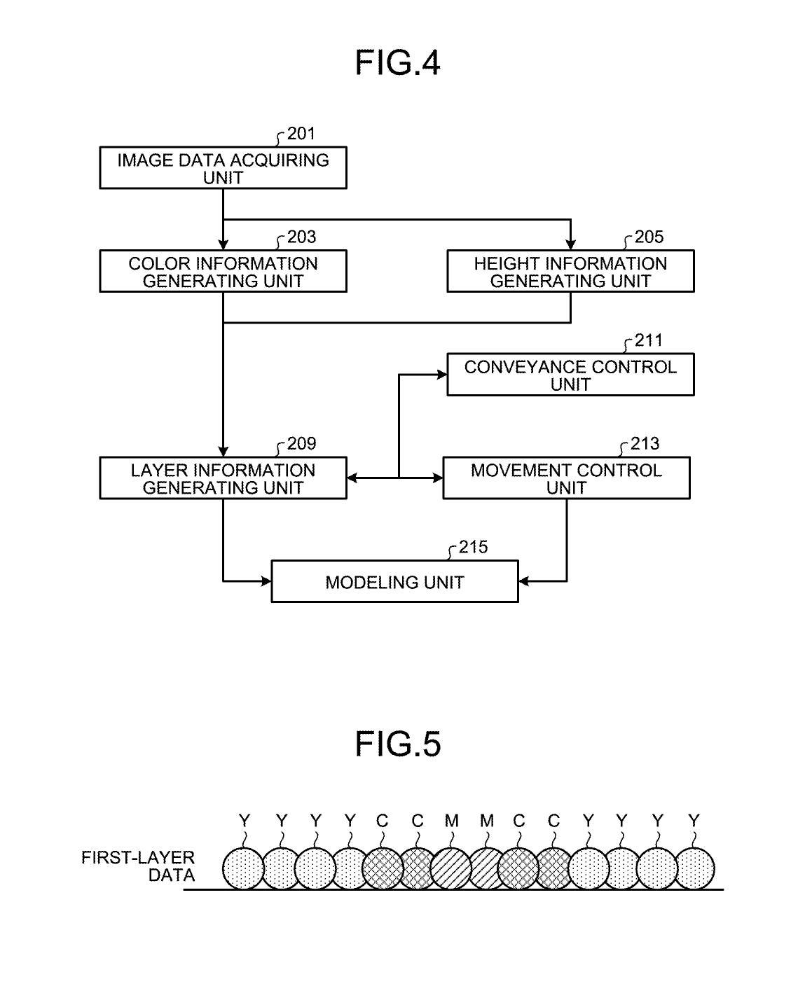

FIG. 4 is a block diagram illustrating an example of a functional configuration of the inkjet recording device 1 according to the present embodiment. As illustrated in FIG. 4, the three-dimensional fabrication apparatus 1 includes an image data acquiring unit 201, a color information generating unit 203, a height information generating unit 205, a layer information generating unit 209, a conveyance control unit 211, a movement control unit 213, and a modeling unit 215.

The image data acquiring unit 201 can be implemented by, for example, the control device 101, the main storage device 102, and the communication device 106. The color information generating unit 203, the height information generating unit 205, the layer information generating unit 209, and the conveyance control unit 211 can be implemented by, for example, the control device 101 and the main storage device 102. The movement control unit 213 and the modeling unit 215 can be implemented by, for example, the head unit 15.

The image data acquiring unit 201 acquires image data of a stereoscopic image. The image data of the stereoscopic image includes, for example, image data obtained by capturing a solid object reproduced by the stereoscopic image (a model of the stereoscopic image). For example, if the solid object reproduced by the stereoscopic image is a painting, the image data of the stereoscopic image may be image data obtained by capturing the painting.

The image data acquiring unit 201 may acquire the image data of the stereoscopic image from an external device such as a personal computer (PC) or may acquire the image data of the stereoscopic image stored in the auxiliary storage device 103. In the present embodiment, a case in which the image data of the stereoscopic image is image data of RGB is explained as an example, however, the image data is not limited thereto.

The color information generating unit 203 generates color information indicating a color of each pixel of the stereoscopic image based on the image data of the stereoscopic image acquired by the image data acquiring unit 201. For example, the color information generating unit 203 generates color information by color-converting the image data of RGB acquired by the image data acquiring unit 201 into image data of CMYK. A known technique should be used for the color conversion (color space conversion) from RGB to CMYK. However, because the generated color information is used to model the stereoscopic image, any processing specific to modeling of the stereoscopic image may be added thereto.

FIG. 5 is a diagram illustrating an example of color information according to the present embodiment. In the present embodiment, as illustrated in FIG. 5, the information for one layer is assumed as the color information. This is because superimposition of colors at the time of laminating the colors may cause degradation of color reproducibility. Therefore, when color information for a plurality of layers is generated, in principle, color information for a first layer is used, and color information for a higher layer than a second layer is not used. In other words, in the present embodiment, the color information is assumed to be two-dimensional information (although the information is illustrated one-dimensionally in FIG. 5).

In the example of FIG. 5, a sign Y indicates that the color of a pixel (hereinafter, it may be called “dot”) is yellow, a sign C indicates that the color of a pixel is cyan, a sign M indicates that the color of a pixel is magenta, and a sign K indicates that the color of a pixel is black. In the following, the color of a pixel having the same pattern as that of the pixel denoted by the sign Y indicates yellow, the color of a pixel having the same pattern as that of the pixel denoted by the sign C indicates cyan, the color of a pixel having the same pattern as that of the pixel denoted by the sign M indicates magenta, and the color of a pixel having the same pattern as that of the pixel denoted by the sign K indicates black.

The height information generating unit 205 generates height information indicating a height of each pixel of the stereoscopic image based on the image data of the stereoscopic image acquired by the image data acquiring unit 201. For the generation of the height information, a known technique for calculating a height (Z coordinate) of each pixel from the two-dimensional image data disclosed in, for example, Japanese Unexamined Patent Application Publication No. 2013-230625 should be used.

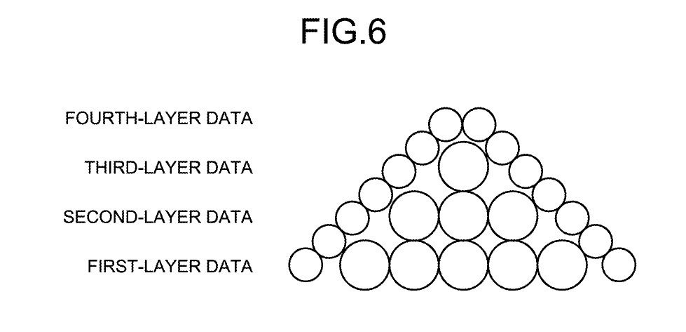

FIG. 6 is a diagram illustrating an example of the height information according to the present embodiment. In the present embodiment, the height information is three-dimensional information (although the information is illustrated two-dimensionally in FIG. 6), and most of the height information represents a pyramid shape with a bottom side as a base as illustrated in FIG. 6. In the example illustrated in FIG. 6, the height information is represented as information for a plurality of layers (four layers). However, this illustration is represented for the sake of convenience so as to simplify the explanation of the layer information generating unit 209 explained later, and actually, the information for layers indicated by the height information is determined by the layer information generating unit 209.

In the example illustrated in FIG. 6, first-layer data indicates five dots that are present in a first stage, second-layer data indicates three dots that are present in a second stage, third-layer data indicates one dot that is present in a third stage, and fourth-layer data indicates 14 dots that are present so as to cover the dots in the first stage to the third stage.

The layer information generating unit 209 generates layer information (slice information) indicating an arrangement of pixels in each layer for modeling the stereoscopic image based on the height information generated by the height information generating unit 205 and the color information generated by the color information generating unit 203.

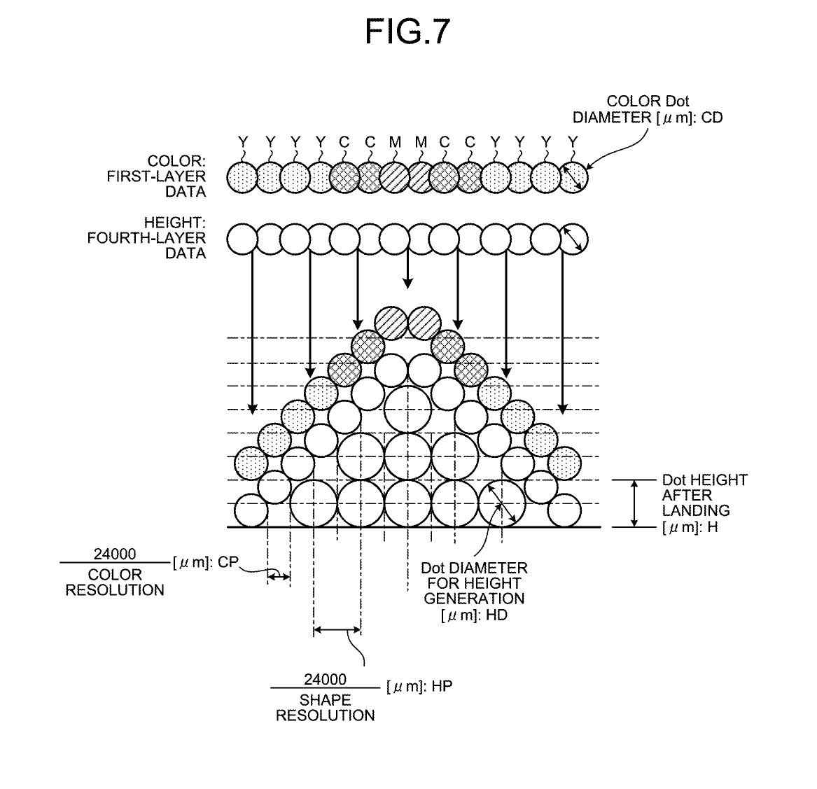

FIG. 7 is an explanatory diagram illustrating an example of a method of generating layer information according to the present embodiment. In the present embodiment, as illustrated in FIG. 7, the layer information generating unit 209 generates stereoscopic image information as an original of the layer information by arranging dots indicated by the color information generated by the color information generating unit 203 on the dots indicated by the height information generated by the height information generating unit 205. In other words, the dots indicated by the height information represent the shape of the stereoscopic image, and the dots indicated by the color information represent colors of the stereoscopic image formed on the shape of the stereoscopic image. The layer information generating unit 209 then generates the layer information indicating an arrangement of pixels in each layer by separating the stereoscopic image information for each layer and dividing the same layer into different layers if necessary.

In the present embodiment, at least an outermost surface of the shape of the stereoscopic image is modeled by laminating droplets discharged with a discharge amount that is less than the discharge amount of the droplets used to model at least part of a shape other than the outermost surface, and colors of the stereoscopic image are formed by laminating droplets discharged with a discharge amount that is less than the discharge amount of the droplets used to model at least the part of the shape other than the outermost surface and is not less than the discharge amount of the droplets used to model the outermost surface. In the present embodiment, the droplet corresponds to an ink droplet of the ultraviolet curable ink.

Specifically, an outer shape of a portion outside a predetermined face within the shape of the stereoscopic image is modeled by laminating droplets discharged with a discharge amount that is less than the discharge amount of the droplets used to model an inner shape of a portion inside the predetermined face within the shape, and colors of the stereoscopic image are formed by laminating droplets discharged with a discharge amount that is less than the discharge amount of the droplets used to model the inner shape and is not less than the discharge amount of the droplets used to model the outer shape.

The predetermined face may be any face if it is a face within the shape of the stereoscopic image. The predetermined face is at least any one of, for example, a conical face, a face where one or more planes are combined, a face where one or more curved surfaces are combined, and a face where one or more planes are combined with one or more curved surfaces.

In the present embodiment, the resolution of each droplet used to model at least the outermost surface exceeds the resolution of each droplet used to model at least the part of the shape other than the outermost surface, and the resolution of each droplet used to form the colors exceeds the resolution of each droplet used to model at least the part of the shape other than the outermost surface and is not higher than the resolution of each droplet used to model at least the outermost surface.

In the present embodiment, the resolution of each droplet used to form the colors is L times (L is a value that exceeds 1) as much as the resolution of each droplet used to model at least the part of the shape other than the outermost surface, and the diameter of each droplet used to form the color is 1/L times the diameter of each droplet used to model at least the part of the shape other than the outermost surface. In the present embodiment, the resolution of each droplet used to model the outermost surface is equal to or slightly higher than the resolution of each droplet used to form the color, and the diameter of each droplet used to model the outermost surface is equal to or slightly smaller than the diameter of each droplet used to form the color. For the droplets used to form the colors, it is preferable to secure the resolution and the diameter of normal print so as not to cause degradation of image quality.

In the present embodiment, the frequency for discharging droplets used to model at least the outermost surface is not higher than the frequency for discharging the droplets used to model at least the part of the shape other than the outermost surface, and the frequency for discharging the droplets used to form the colors is not higher than the frequency for discharging the droplets used to model at least the part of the shape other than the outermost surface and is not less than the frequency for discharging the droplets used to model at least the outermost surface.

Below is an explanation of a case, as an example, where a shape other than the outermost surface of the shape of the stereoscopic image is modeled under the conditions of resolution: 300 dpi, printing speed: 1680 mm/sec, and discharge frequency: 20 kHz, and the outermost surface of the shape of the stereoscopic image is modeled and the colors of the stereoscopic image are formed under the conditions of resolution: 600 dpi, printing speed: 840 mm/sec, and discharge frequency: 20 kHz; however, the embodiment is not limited thereto.

According to the conditions, the following relation holds: “Discharge amount (diameter of a droplet) of droplets used to model a shape other than the outermost surface of the shape of a stereoscopic image>Discharge amount (diameter of a droplet) of droplets used to model the outermost surface of the shape of the stereoscopic image=Discharge amount (diameter of a droplet) of droplets used to form colors of the stereoscopic image”.

Therefore, in the present embodiment, the heights of layers indicated by the layer information are not uniform, and the height of the layer constituting the outermost surface of the shape of the stereoscopic image and the height of the layer constituting the colors of the stereoscopic image are lower than the layer constituting the shape other than the outermost surface of the shape of the stereoscopic image. Specifically, the height of layers constituting the shape other than the outermost surface of the shape of the stereoscopic image becomes a height (Dot height after landing) H when Dot determined based on 25400/HP being a resolution (shape resolution) of a dot for height generation and a dot diameter HD for height generation is formed with the ultraviolet curable ink (see FIG. 7). The height of the layer constituting the colors of the stereoscopic image becomes a height when Dot determined by 25400/CP being a resolution (color resolution) of a color dot and by a color dot diameter CD is formed with the ultraviolet curable ink (see FIG. 7). Because the height of the layer constituting the outermost surface of the shape of the stereoscopic image is equal to the height of the layer constituting the colors of the stereoscopic image, description thereof is omitted.

In other words, in the present embodiment, when the layer is used to model the outermost surface of the shape of the stereoscopic image, the layer information indicates that the layer is laminated by discharging droplets corresponding to pixels with a discharge amount that is less than the discharge amount of the droplets used to model at least the part of the shape other than the outermost surface in the shape.

Likewise, when the layer is used to form the colors of the stereoscopic image, the layer information indicates that the layer is laminated by discharging droplets corresponding to pixels with a discharge amount that is less than the discharge amount of the droplets used to model at least the part of the shape other than the outermost surface of the shape of the stereoscopic image and is not less than the discharge amount of the droplets used to model the outermost surface.

The conveyance control unit 211 controls the conveyance of the recording medium on which the stereoscopic image is modeled by the head unit 15.

The movement control unit 213 controls the movement of the head unit 15.

The modeling unit 215 models the stereoscopic image by laminating the ultraviolet curable ink on the recording medium based on the layer information for each layer generated by the layer information generating unit 209.

Specifically, the modeling unit 215 discharges and laminates droplets corresponding to each pixel based on the height information (in detail, the layer information corresponding to the height information) indicating the height of each pixel of the stereoscopic image and models the shape of the stereoscopic image, and discharges and laminates droplets corresponding to each pixel on the modeled shape based on the color information (in detail, the layer information corresponding to the color information) indicating the color of each pixel of the stereoscopic image to form the colors on the shape, and models the shape of the stereoscopic image.

In this case, the modeling unit 215 models at least the outermost surface of the shape of the stereoscopic image by laminating droplets discharged with a discharge amount that is less than the discharge amount of the droplets used to model at least the part of the shape other than the outermost surface in the shape, and forms the colors of the stereoscopic image by laminating droplets discharged with a discharge amount that is less than the discharge amount of the droplets used to model at least the part of the shape other than the outermost surface in the shape and is not less than the discharge amount of the droplets used to model the outermost surface.

In detail, the modeling unit 215 models the outer shape of a portion outside the predetermined face within the shape of the stereoscopic image by laminating droplets discharged with a discharge amount that is less than the discharge amount of the droplets used to model the inner shape of a portion inside the predetermined face within the shape, and forms the colors of the stereoscopic image by laminating droplets discharged with a discharge amount that is less than the discharge amount of the droplets used to model the inner shape and is not less than the discharge amount of the droplets used to model the outer shape.

In the present embodiment, the modeling unit 215 models the outermost surface of the shape of the stereoscopic image by laminating the droplets discharged with the discharge amount that is less than the discharge amount of the droplets used to model the shape other than the outermost surface, and forms the colors of the stereoscopic image by laminating the droplets discharged with the discharge amount that is less than the discharge amount of the droplets used to model the shape other than the outermost surface and is not less than the discharge amount of the droplets used to model the outermost surface.

In the present embodiment, as explained above, the resolution of the droplets used to model at least the outermost surface exceeds the resolution of the droplets used to model at least the part of the shape other than the outermost surface, and the resolution of the droplets used to form the colors exceeds the resolution of the droplets used to model at least the part of the shape other than the outermost surface and is not higher than the resolution of the droplets used to model at least the outermost surface.

In the present embodiment, as explained above, the frequency for discharging the droplets used to model at least the outermost surface is not higher than the frequency for discharging the droplets used to model at least the part of the shape other than the outermost surface, and the frequency for discharging the droplets used to form the colors is not higher than the frequency for discharging the droplets used to model at least the part of the shape other than the outermost surface and is not less than the frequency for discharging the droplets used to model at least the outermost surface.

Below is the explanation of the case, as an example, where the modeling unit 215 models the shape other than the outermost surface of the shape of the stereoscopic image under the conditions of resolution: 300 dpi, printing speed: 1680 mm/sec, and discharge frequency: 20 kHz, and models the outermost surface of the shape of the stereoscopic image and forms the colors of the stereoscopic image under the conditions of resolution: 600 dpi, printing speed: 840 mm/sec, and discharge frequency: 20 kHz.

The modeling unit 215 uses the ultraviolet curable ink of a color different from the color indicated by the color information for modeling the shape of the stereoscopic image. In the present embodiment, the modeling unit 215 uses the ultraviolet curable ink of white (W) for modeling the shape of the stereoscopic image, however, the color is not limited thereto, and, therefore, may use the ultraviolet curable ink of clear (CL) or may use a combination of the ultraviolet curable ink of white (W) and the ultraviolet curable ink of clear (CL).

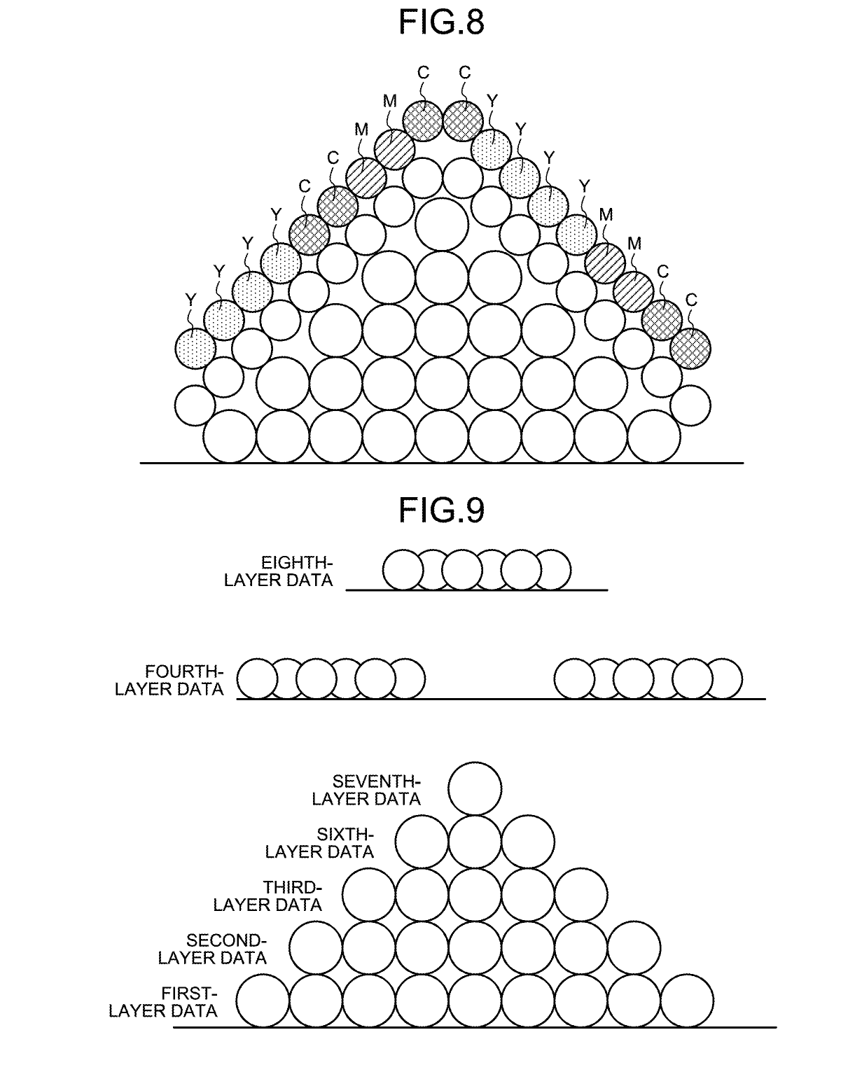

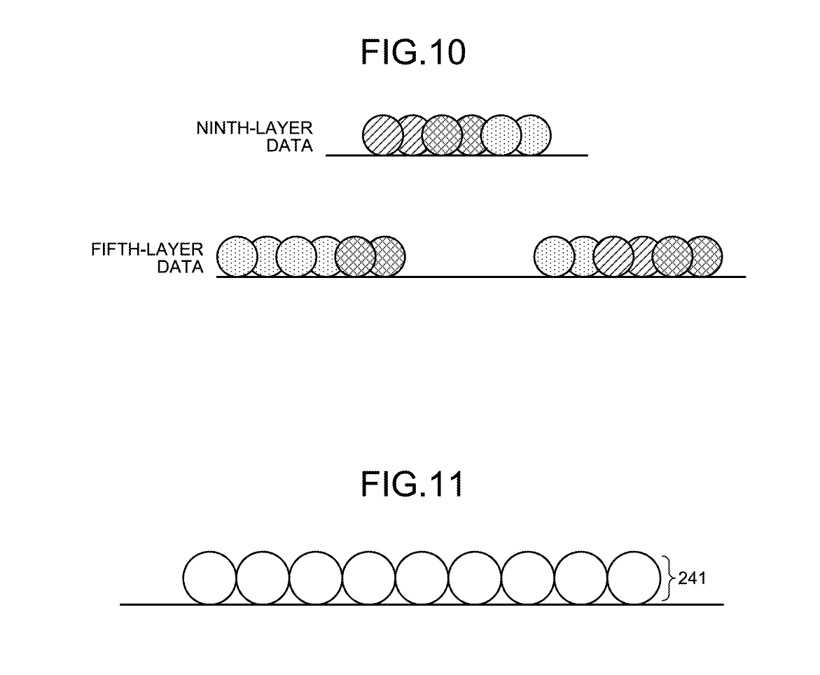

A lamination method according to the present embodiment will be specifically explained below. A case where the stereoscopic image illustrated in FIG. 8 is modeled will be explained below as an example. The layer information in this case is as illustrated in FIG. 9 and FIG. 10. The layer information illustrated in FIG. 9 is the layer information for modeling the shape of the stereoscopic image illustrated in FIG. 8, and the layer information illustrated in FIG. 10 is the layer information for forming the colors of the stereoscopic image illustrated in FIG. 8.

In the layer information for the shape illustrated in FIG. 9, a first layer indicates dots for the shape in a first stage of the stereoscopic image illustrated in FIG. 8, a second layer indicates dots for the shape in a second stage of the stereoscopic image illustrated in FIG. 8, a third layer indicates dots for the shape in a third stage of the stereoscopic image illustrated in FIG. 8, a fourth layer indicates 12 dots except for 6 dots in the center of 18 dots for the shape of the outermost surface that are present so as to cover the dots for the shape that are present in the first stage to the fifth stage, a six layer indicates dots for the shape in a fourth stage of the stereoscopic image illustrated in FIG. 8, a seventh layer indicates a dot for the shape in a fifth stage of the stereoscopic image illustrated in FIG. 8, and an eighth layer indicates 6 dots in the center of the 18 dots for the shape of the outermost surface illustrated in FIG. 8.

In the layer information for the colors illustrated in FIG. 10, a fifth layer represents 12 dots except for 6 dots in the center of 18 dots for the colors that are present so as to cover the 18 dots for the shape of the outermost surface of the stereoscopic image illustrated in FIG. 8, and a ninth layer represents 6 dots in the center of the 18 dots for the colors of the stereoscopic image illustrated in FIG. 8.

First of all, as illustrated in FIG. 11, the modeling unit 215 discharges ink droplets of the ultraviolet curable ink of white (W) and laminates dots 241 for the shape indicated by the layer information of the first layer illustrated in FIG. 9 on the recording medium.

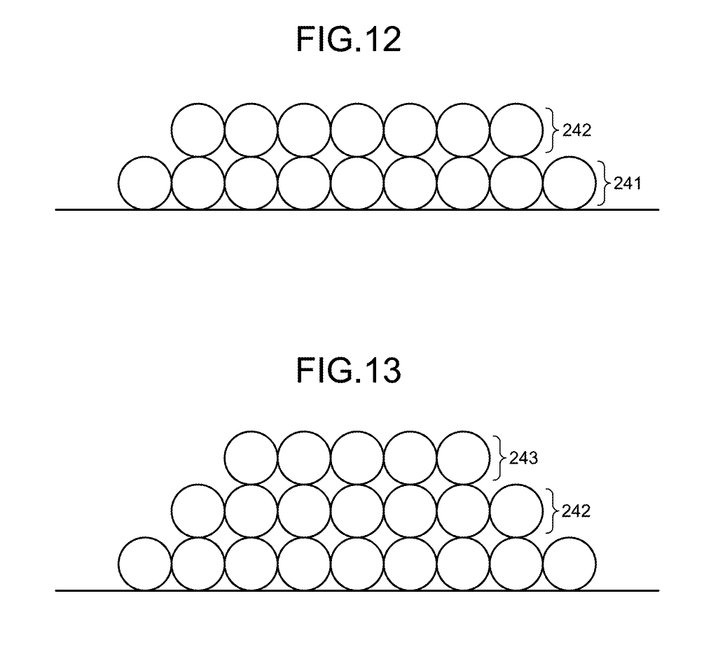

Then, as illustrated in FIG. 12, the modeling unit 215 discharges ink droplets of the ultraviolet curable ink of white (W) and laminates dots 242 for the shape indicated by the layer information of the second layer illustrated in FIG. 9 on the dots 241 for the shape.

As illustrated in FIG. 13, the modeling unit 215 discharges ink droplets of the ultraviolet curable ink of white (W) and laminates dots 243 for the shape indicated by the layer information of the third layer illustrated in FIG. 9 on the dots 242 for the shape.

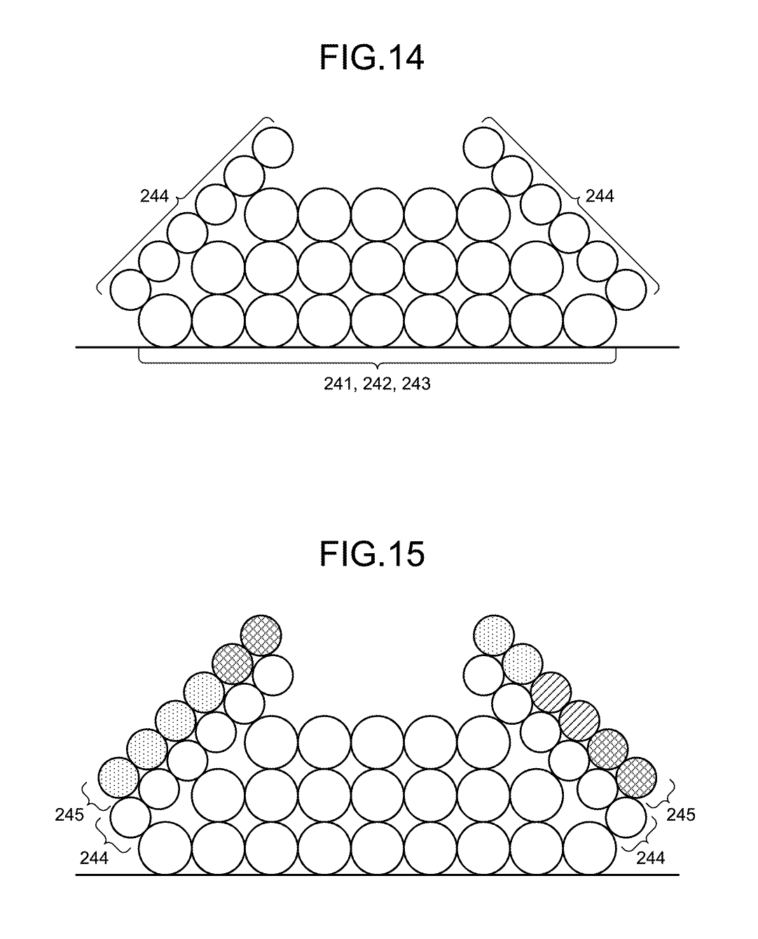

As illustrated in FIG. 14, the modeling unit 215 discharges ink droplets of the ultraviolet curable ink of white (W) and laminates dots 244 for the shape of the outermost surface indicated by the layer information of the fourth layer illustrated in FIG. 9 on a conical part of the dots 241 to 243 for the shape.

As illustrated in FIG. 15, the modeling unit 215 discharges ink droplets of the ultraviolet curable inks for the colors such as yellow (Y), cyan (C), and magenta (M) and laminates dots 245 for the colors indicated by the layer information of the fifth layer illustrated in FIG. 10 on the dots 244 for the shape of the outermost surface.

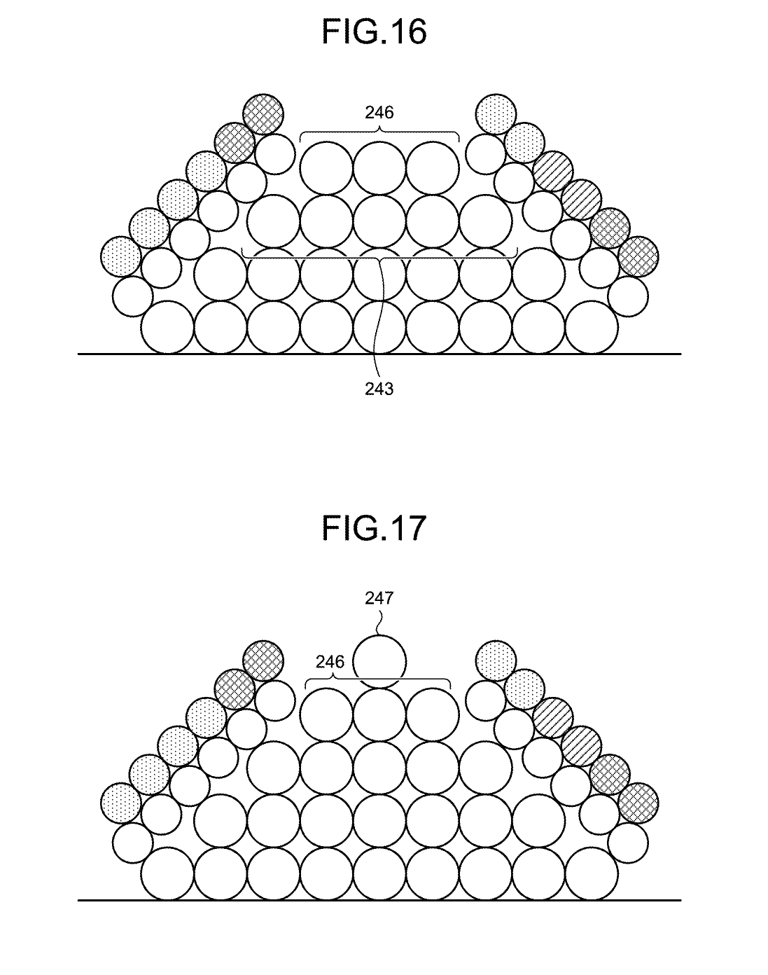

As illustrated in FIG. 16, the modeling unit 215 discharges ink droplets of the ultraviolet curable ink of white (W) and laminates dots 246 for the shape indicated by the layer information of the sixth layer illustrated in FIG. 9 on the dots 243 for the shape.

As illustrated in FIG. 17, the modeling unit 215 discharges ink droplets of the ultraviolet curable ink of white (W) and laminates a dot 247 for the shape indicated by the layer information of the seventh layer illustrated in FIG. 9 on the dots 246 for the shape.

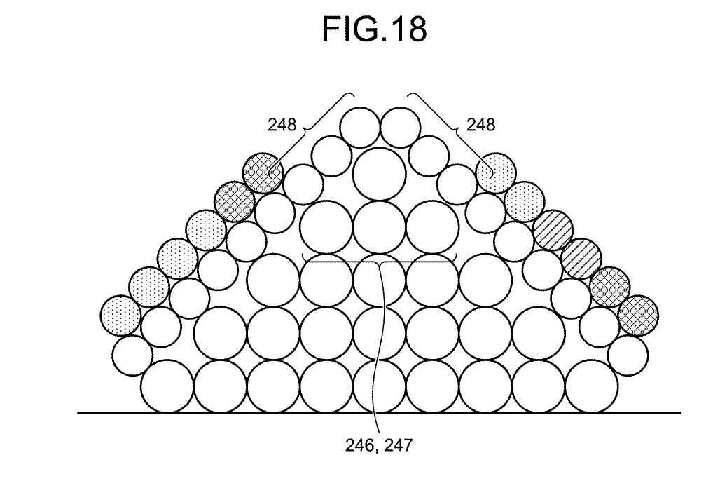

As illustrated in FIG. 18, the modeling unit 215 discharges ink droplets of the ultraviolet curable ink of white (W) and laminates dots 248 for the shape of the outermost surface indicated by the layer information of the eighth layer illustrated in FIG. 9 on a conical part of the dots 246 to 247 for the shape.

Lastly, the modeling unit 215 discharges ink droplets of the ultraviolet curable inks for the colors and laminates dots for the colors indicated by the layer information of the ninth layer illustrated in FIG. 10 on the dots 248 for the shape of the outermost surface. Thus, the stereoscopic image illustrated in FIG. 18 is modeled.

In the lamination method explained with reference to FIG. 8 to FIG. 18, the shape other than the outermost surface of the stereoscopic image, the outermost surface, and the colors are not modeled at one time, but are modeled separately in two stages. This is because when the outermost surface is modeled and the colors are formed after the shape other than the outermost surface of the stereoscopic image is modeled, a gap between heads (distance between the inkjet head 14 and a landing position of an ink droplet) at the time of modeling the outermost surface and the colors becomes large, and this results in reduction of the landing accuracy, which causes degradation of the image quality.

Therefore, in the present embodiment, in consideration of the gap between heads, the layer information indicating an arrangement of pixels on each layer is generated by separating the same layer into different layers if necessary.

Generally, because the gap between heads is preferably 0.5 mm or less, the number of limit layers is 0.5 H. For example, if H=25 μm, the number of limit layers=20 layers. Therefore, the layer information should be generated so as to repeat the operation of modeling the outermost surface and the colors each time 20 layers for the shape other than the outermost surface of the stereoscopic image are modeled.

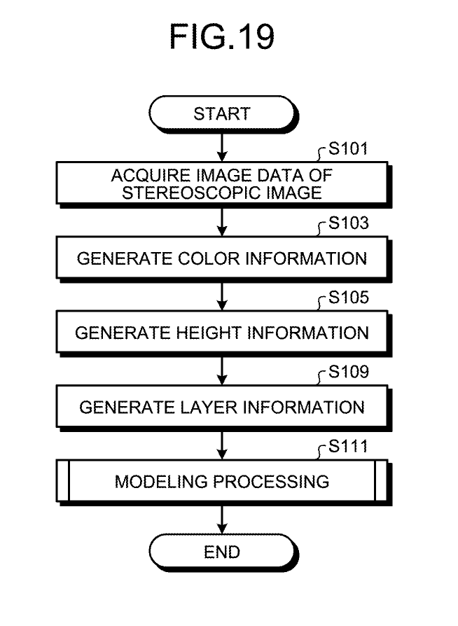

FIG. 19 is a flowchart illustrating an example of a flow of production processing procedure of an output object (an output object obtained by laminating droplets on the recording medium to model a stereoscopic image) according to the present embodiment.

First of all, the image data acquiring unit 201 acquires image data of the stereoscopic image (Step S101).

Then, the color information generating unit 203 generates color information indicating a color of each pixel of the stereoscopic image based on the image data of the stereoscopic image acquired by the image data acquiring unit 201 (Step S103).

Subsequently, the height information generating unit 205 generates height information indicating a height of each pixel of the stereoscopic image based on the image data of the stereoscopic image acquired by the image data acquiring unit 201 (Step S105).

The layer information generating unit 209 then generates layer information for each layer for modeling the stereoscopic image based on the color information generated by the color information generating unit 203 and the height information corrected by the correction unit 207 (Step S109).

Subsequently, the modeling unit 215 performs modeling processing for laminating the ultraviolet curable inks on the recording medium based on the layer information for each layer generated by the layer information generating unit 209 and modeling the corrected stereoscopic image (Step S111).

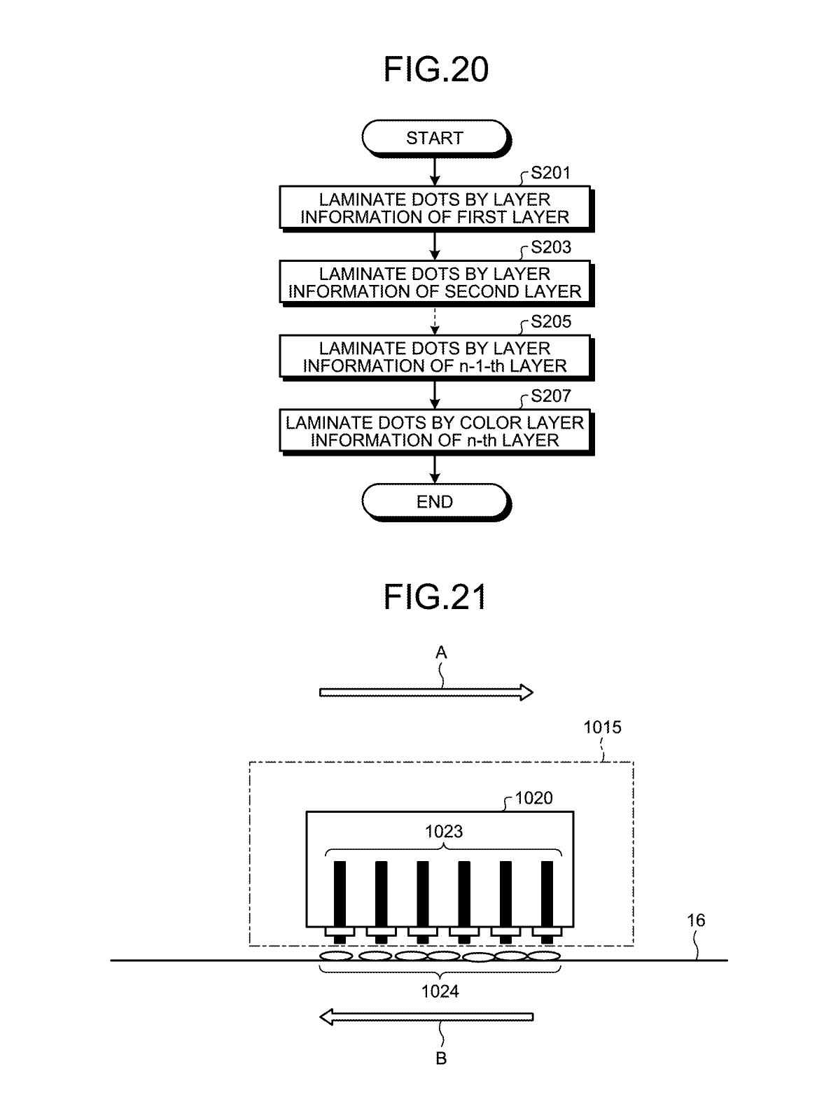

FIG. 20 is a flowchart illustrating an example of modeling processing at Step S111 in the flowchart of FIG. 19.

First of all, the modeling unit 215 discharges ink droplets of the ultraviolet curable ink and laminates dots indicated by the layer information of the first layer on the recording medium (Step S201).

Then, the modeling unit 215 discharges ink droplets of the ultraviolet curable ink and laminates dots indicated by the layer information of the second layer on the dots indicated by the layer information of the first layer (Step S203).

Hereinafter, the same processing is repeated, and the modeling unit 215 discharges ink droplets of the ultraviolet curable ink and laminates dots indicated by the layer information of n−1-th layer on the dots indicated by the layer information of n−2-th layer (Step S205).

Lastly, the modeling unit 215 discharges ink droplets of the ultraviolet curable ink and laminates dots indicated by the layer information of n-th layer on the dots indicated by the layer information of n−1-th layer (Step S207).

At the step of modeling the outermost surface of the stereoscopic image among the steps illustrated in FIG. 20, the outermost surface is modeled by laminating the droplets discharged with the discharge amount that is less than the discharge amount of the droplets used to model the shape other than the outermost surface of the stereoscopic image.

At the step of forming colors of the stereoscopic image among the steps illustrated in FIG. 20, the colors are formed by laminating the droplets discharged with the discharge amount that is less than the discharge amount of the droplets used to model the shape other than the outermost surface of the stereoscopic image and is not less than the discharge amount of the droplets used to model the outermost surface.

As a result, for the output object generated according to the flowcharts illustrated in FIG. 20 and FIG. 21, at least the outermost surface of the shape of the stereoscopic image is modeled by laminating the droplets discharged with the discharge amount that is less than the discharge amount of the droplets used to model at least the part of the shape other than the outermost surface in the shape, and the colors of the stereoscopic image are formed by laminating the droplets discharged with the discharge amount that is less than the discharge amount of the droplets used to model at least the part of the shape other than the outermost surface in the shape and is not less than the discharge amount of the droplets used to model the outermost surface, on the shape.

As explained above, in the present embodiment, the diameter of the dots that form at least the outermost surface of the shape of the stereoscopic image is less than the diameter of the dots that form at least the part of the shape other than the outermost surface, and the diameter of the dots that form the colors of the stereoscopic image is less than the diameter of the dots that form at least the part of the shape other than the outermost surface and is not less than the diameter of the dots that form the outermost surface.

Therefore, according to the present embodiment, because the outermost surface of the shape of the stereoscopic image can be made smooth, it is possible to suppress the irregularities on the outermost surface of the shape of the stereoscopic image and to suppress the influence of the irregularities on the colors formed on the shape of the stereoscopic image, thus improving the color reproducibility.

Moreover, in the present embodiment, the printing speed of the dots forming at least the part of the shape other than the outermost surface of the shape of the stereoscopic image can be made faster than the printing speed of the dots forming at least the outermost surface of the shape of the stereoscopic image and of the dots forming the colors of the stereoscopic image.

Therefore, according to the present embodiment, the shape of part with less influence on the colors of the stereoscopic image can be printed at a printing speed higher than that of the outermost surface of the shape of the stereoscopic image or than that of the colors of the stereoscopic image, thus improving the productivity while improving the color reproducibility. Particularly, if bidirectional printing instead of unidirectional printing is performed on the shape of part with less influence on the colors of the stereoscopic image, the productivity can be further improved.

When the discharge frequency is fixed, the printing speed can be increased by reducing the resolution, but for the shape of part with less influence on the colors of the stereoscopic image, because there is less influence on the colors even if the resolution is reduced, it is possible to deal with an increase in the printing speed by reducing the resolution.

In the present embodiment, the diameter of the dots that form the outermost surface of the shape of the stereoscopic image is less than the diameter of the dots that form at least the part of the shape other than the outermost surface. However, the diameter of the dots that form lower layers below the outermost surface of the shape of the stereoscopic image may be the same as the diameter of the dots that form the outermost surface.

By doing in this way, the outermost surface of the shape of the stereoscopic image can be smoothed, and it is therefore possible to further suppress the irregularities on the outermost surface of the shape of the stereoscopic image and to further suppress the influence of the irregularities on the colors formed on the shape of the stereoscopic image, thus improving the color reproducibility.

In the present embodiment, the resolution is changed in order to improve the productivity, however, if the discharge amount of the droplets is set to the conditions as above, the color reproducibility can be improved even if the resolution is fixed.

First Modification

In the embodiment, the inkjet method has been explained, however, in a first modification, a mechanical configuration of a head unit 1015 when modeling is performed by a melt deposition method will be explained below.

FIG. 21 is a schematic diagram illustrating an example of a mechanical configuration of the head unit 1015 according to the first modification. As illustrated in FIG. 21, the head unit 1015 includes a thermal head 1020.

The thermal head 1020 includes melt ink 1023, and heats the melt ink 1023 to thereby output the melt ink droplets 1024 to the recording medium 16. The melt ink 1023 includes melt inks of white (W), clear (CL), yellow (Y), cyan (C), magenta (M), and black (k) similar to the inkjet method.

Second Modification

In the embodiment, the height information generating unit 205 may generate height information by three-dimensionally measuring a solid object reproduced by the stereoscopic image. The height information generating unit 205 may generate height information by combining the image data of the stereoscopic image acquired by the image data acquiring unit 201 with the three-dimensional measurement of the solid object reproduced by the stereoscopic image.

Third Modification

In the embodiment, the height information generating unit 205 may be configured to acquire the height information of the stereoscopic image. For example, when the solid object reproduced by the stereoscopic image is a painting or the like, there is a case where the height information is managed as data in an art museum or the like that stores the painting. In this case, the height information generating unit 205 may acquire the height information of the stereoscopic image from outside the device.

Fourth Modification

In the embodiment, the example in which the modeling unit 215 uses the ultraviolet curable ink of a color different from the color indicated by the color information to model the shape of the stereoscopic image has been explained. However, the ultraviolet curable ink of a color different from the color indicated by the color information may be used to model the portion, where the colors indicated by the color information are laminated, in the shape of the stereoscopic image, and the ultraviolet curable ink of any color may be used to model a portion other than the portion. By doing this, it is possible to improve a modeling speed of the stereoscopic image while improving the color reproducibility of the stereoscopic image.

Programs

The programs executed by the three-dimensional fabrication apparatus 1 according to the present embodiment and the modifications are provided by being recorded in a computer-readable recording medium such as a compact disk read only memory (CD-ROM), compact disk recordable (CD-R), a memory card, a digital versatile disk (DVD), and a flexible disk (FD) in an installable or executable file format.

The programs executed by the three-dimensional fabrication apparatus 1 according to the embodiment and the modifications may be configured to be provided by being stored on a computer connected to a network such as the Internet and being downloaded via the network. The programs executed by the three-dimensional fabrication apparatus 1 according to the embodiment and the modifications may also be configured to be provided or distributed via a network such as the Internet. The programs executed by the three-dimensional fabrication apparatus 1 according to the present embodiment and the modifications may be configured to be provided by being preinstalled in a ROM or the like.

The programs executed by the three-dimensional fabrication apparatus 1 according to the embodiment and the modifications are configured as modules in order to implement the units on a computer. Actual hardware is configured so that the function units are implemented by the CPU executing the program that is read from a ROM onto a RAM.

According to the exemplary embodiments of the present invention, it is possible to improve the color reproducibility of a modeled solid.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. A three-dimensional fabrication apparatus comprising:
a modeling unit configured to model a shape of a stereoscopic image by discharging and laminating droplets corresponding to a pixel based on height information indicating a height of each pixel of the stereoscopic image and to model the stereoscopic image by discharging and laminating droplets corresponding to the pixel on the modeled shape to form a color on the shape based on color information indicating a color of each pixel of the stereoscopic image, wherein
the modeling unit is configured to
model at least an outermost surface of the shape by laminating droplets discharged with a discharge amount that is less than the discharge amount of the droplets used to model at least part of a shape other than the outermost surface in the shape, and
form the color by laminating droplets discharged with a discharge amount that is less than the discharge amount of the droplets used to model at least the part of the shape other than the outermost surface in the shape and is not less than the discharge amount of the droplets used to model the outermost surface.

2. The three-dimensional fabrication apparatus according to claim 1, wherein
the modeling unit is configured to
model an outer shape of a portion outside a predetermined face within the shape by laminating droplets discharged with a discharge amount that is less than a discharge amount of droplets used to model an inner shape of a portion inside the predetermined face within the shape, and
form the color by laminating droplets discharged with a discharge amount that is less than the discharge amount of the droplets used to model the inner shape and is not less than the discharge amount of the droplets used to model the outer shape.

3. The three-dimensional fabrication apparatus according to claim 2, wherein
the predetermined face is at least any one of a conical face, a face where one or more planes are combined, a face where one or more curved surfaces are combined, and a face where one or more planes are combined with one or more curved surfaces.

4. The three-dimensional fabrication apparatus according to claim 1, wherein
the modeling unit is configured to
model the outermost surface by laminating droplets discharged with a discharge amount that is less than the discharge amount of droplets used to model the shape other than the outermost surface, and
form the color by laminating droplets discharged with a discharge amount that is less than the discharge amount of the droplets used to model the shape other than the outermost surface and is not less than the discharge amount of the droplets used to model the outermost surface.

5. The three-dimensional fabrication apparatus according to claim 1, wherein
a resolution of the droplets used to model at least the outermost surface exceeds a resolution of the droplets used to model at least the part of the shape other than the outermost surface, and
a resolution of the droplets used to form the color exceeds a resolution of the droplets used to model at least the part of the shape other than the outermost surface and is not higher than the resolution of the droplets used to model at least the outermost surface.

6. The three-dimensional fabrication apparatus according to claim 1, wherein
a frequency for discharging the droplets used to model at least the outermost surface is not higher than a frequency for discharging the droplets used to model at least the part of the shape other than the outermost surface, and
a frequency for discharging the droplets used to form the color is not higher than the frequency for discharging the droplets used to model at least the part of the shape other than the outermost surface and is not less than the frequency for discharging the droplets used to model at least the outermost surface.

7. An information processing device comprising:
a layer information generating unit configured to generate layer information indicating an arrangement of pixels on each layer for modeling a stereoscopic image based on height information indicating a height of each pixel of the stereoscopic image and color information indicating a color of each pixel of the stereoscopic image, wherein,
when the layer is a layer for modeling an outermost surface of a shape of the stereoscopic image, the layer information indicates lamination of the layer by discharging droplets corresponding to a pixel with a discharge amount that is less than a discharge amount of droplets used to model at least part of a shape other than the outermost surface in the shape, and
when the layer is a layer for forming colors of the stereoscopic image, the layer information indicates lamination of the layer by discharging droplets corresponding to a pixel with a discharge amount that is less than the discharge amount of droplets used to model at least the part of the shape other than the outermost surface in the shape and is not less than the discharge amount of droplets used to model the outermost surface.

8. A production method of an output object configured to produce the output object by laminating droplets to model a stereoscopic image on a recording medium, the production method comprising:
modeling a shape of the stereoscopic image on the recording medium by discharging and laminating droplets corresponding to a pixel on the recording medium based on height information indicating a height of each pixel of the stereoscopic image, and modeling the stereoscopic image on the recording medium by discharging and laminating droplets corresponding to a pixel on the modeled shape and forming colors on the shape based on color information indicating a color of each pixel of the stereoscopic image, wherein
the modeling configured to include
modeling at least part of a shape other than an outermost surface in the shape by discharging and laminating droplets,
modeling the outermost surface by laminating droplets discharged with a discharge amount that is less than the discharge amount of the droplets used to model at least the part of the shape other than the outermost surface in the shape, and
forming the color by laminating droplets discharged with a discharge amount that is less than the discharge amount of the droplets used to model at least the part of the shape other than the outermost surface in the shape and is not less than the discharge amount of the droplets used to model the outermost surface.
